(19) United States
(12) Patent Application Publication
(10) Pub. No.: US 2026/0236323 A1
(43) Pub. Date: Aug. 13, 2026

(54) METHOD AND SCHEDULING APPARATUS FOR ALLOCATING RESOURCES OF CLOUD SERVER

(71) Applicant: CLOUD INTELLIGENCE ASSETS HOLDING (SINGAPORE) PRIVATE LIMITED, Singapore (SG)

(72) Inventor: Fei PENG, Hangzhou, Zhejiang (CN)

(21) Appl. No.: 19/155,224

(22) PCT Filed: Apr. 10, 2024
(86) PCT No.: PCT/CN2024/087060

§ 371 Date: Aug. 8, 2025

(30) Foreign Application Priority Data
Apr. 14, 2023 (CN) 202310418394.1

(51) Int. Cl. G06F 9/50

(52) U.S. Cl. CPC G06F 9/5083

(57) ABSTRACT

The present disclosure relates to a method and scheduling apparatus for allocating resources of a cloud server. The method includes that: after the cloud server initially allocates an exclusive resource to a user, a resource demand of the user is acquired in a target time period, where the exclusive resource is a resource of the cloud server pre-allocated to the user and exclusively used by the user; allocation information of the exclusive resource for the user is modified according to the resource demand; and the exclusive resource is allocated, according to the allocation information, to the user in the target time period.

The present disclosure claims priority of Chinese Patent Application No. CN202310418394.1, filed to China National Intellectual Property Administration on Apr. 14, 2023 and titled “METHOD AND SCHEDULING APPARATUS FOR ALLOCATING RESOURCES OF CLOUD SERVER”, the content of which is hereby incorporated by reference in its entirety.

### TECHNICAL FIELD

The present disclosure relates to the technical field of computers, and in particular to a method and scheduling apparatus for allocating resources of a cloud server.

### BACKGROUND OF THE INVENTION

A variety of delivery forms of resources are available to a cloud server, including an exclusive resource. When the cloud server is initialized, a size of the exclusive resource is determined and is unchangeable during use of the cloud server. In order to guarantee data stability, a user of the cloud server generally determines the size of the exclusive resource according to a resource demand peak. However, a resource demand of the user does not remain unchanged, but fluctuates greatly, resulting in resource cost waste during a data valley period and shortage of usable resources during a data peak period.

Thus, resource waste of the cloud server or shortage of resources usable to the user is caused since a method for allocating resources of the cloud server in the related art hardly adapts to a dynamic fluctuant resource demand of the user.

It should be noted that this part is intended to provide a background or context for the embodiments of the present disclosure stated in the claims. The description herein included in this part should not be acknowledged as the related art.

### SUMMARY OF THE INVENTION

Embodiments of the present disclosure provide a method and scheduling apparatus for allocating resources of a cloud server, so as at least to solve the problem that resource waste of the cloud server or shortage of resources usable to a user is caused since the method for allocating resources of the cloud server in the related art hardly adapts to a dynamic fluctuant resource demand of dynamic fluctuation of the user.

A method for allocating resources of a cloud server is provided in some embodiments of the present disclosure. The method includes that: after the cloud server initially allocates an exclusive resource to a user, a resource demand of the user is acquired in a target time period, where the exclusive resource is a resource of the cloud server pre-allocated to the user and exclusively used by the user; allocation information of the exclusive resource for the user is modified according to the resource demand; and the exclusive resource is allocated, according to the allocation information, to the user in the target time period.

The embodiments of the present disclosure has the beneficial effects. The allocation information is reconfigured before the target time period according to the resource demand of the user in the target time period, and the resources are allocated according to the allocation information in the target time period. Thus, the exclusive resource is dynamically allocated, so as to guarantee that the additional exclusive resource used and placed is dynamically adjusted according to a demand of the exclusive resource, thereby avoiding the situation that a static exclusive resource hardly satisfies a dynamic fluctuant resource demand, and solving the problem of resource waste or resource shortage for the user of the cloud server.

In some optional embodiments, an operation of acquiring the resource demand of the user in the target time period includes that: the resource demand is determined according to demand information input by the user; or, the resource demand is predicted according to historical data for performing resource allocation by the user, where the historical data is information for performing resource allocation by the user in a historical time period.

The resource demand of the user is determined according to the demand information input by the user, and better conforms to an actual resource demand of the user. The resource demand of the user is further predicted according to the historical data of the user, and it is unnecessary for the user to actually participate in dynamic adjustment of the resource allocation, thereby improving use experience, and preventing workload of the user from being increased. The resource demand is selected according to an actual situation during use, thereby improving flexibility of the solution.

In some optional embodiments, an operation of predicting the resource demand according to historical data for performing resource allocation by the user includes that: historical load data of the cloud server is collected to extract the historical data, where the historical load data includes the historical data on resource provision by the cloud server for the user; and the resource demand is predicted according to the historical data.

The historical load data recorded by the cloud server is reasonably used to extract the historical data according to the historical load data recorded by the cloud server, so as to predict the resource demand of the user. The user does not need to provide the historical data, thereby improving efficiency of demand prediction.

In some optional embodiments, the historical data on resource provision by the cloud server for the user includes historical allocation data of each demand level in the historical time period, and an operation of collecting historical load data of the cloud server to extract the historical data for performing resource allocation by the user includes that: resource data occupied by data having a demand level reaching a preset level in the historical load data is set as the historical allocation data of the exclusive resource.

The historical allocation data of the exclusive resource is extracted from the historical load data according to the resource data occupied by the data having the demand level reaching the preset level. The corresponding exclusive resource in the historical load data determined according to division of the preset level is set as the historical allocation data, and the exclusive resource recorded according to the historical load data is not directly set as the historical allocation data, such that the demand of the user can be better satisfied, thereby solving the problem of inaccurate resource demand prediction caused by a change in a use demand.

In some optional embodiments, an operation of modifying allocation information of the exclusive resource for the user according to the resource demand includes that: pre-allocation information corresponding to the resource demand is generated, where resource data allocated in the pre-allocation information is the same as resource data in the resource demand; verification information required by the pre-allocation information is sent to the user; and the pre-allocation information is set as the allocation information in response to the verification information being verified.

The resource of the cloud server is re-allocated, and the allocated resource is changed, thereby affecting use by the user. Thus, the pre-allocation information needs to be determined according to the resource demand, and is sent to the user for verification and confirmation. The pre-allocation information is set as the allocation information to allocate the resources in response to the verification information being verified.

In some optional embodiments, the verification required by the pre-allocation information includes payment verification, verification information of the payment verification includes a payment link, and an operation of sending verification information required by the pre-allocation information to the user includes that: the payment link of the payment verification is sent to the user; and it is determined that the payment verification succeeds in response to payment having been successfully processed via the payment link.

The resources of the cloud server are paid resources provided, and the payment verification is performed by means of the payment link. The pre-allocation information is set as allocation information to allocate the resources in the target time period in response to the verification information being verified.

In some optional embodiments, an operation of allocating, according to the allocation information, the exclusive resource to the user in the target time period includes that: current allocation information for performing resource allocation by the user is acquired in a current time period, where the target time period is a next time period after the current time period; the current allocation information is adjusted to the allocation information in the target time period in response to the current allocation information being inconsistent with the allocation information; and the resource allocation is executed according to the current allocation information in the target time period in response to the current allocation information being consistent with the allocation information.

When the resources of the cloud server are allocated according to the allocation information, whether the current allocation information of the current time period is consistent with the allocation information is compared. The resources are re-allocated in response to the current allocation information being inconsistent with the allocation information. The resources are not re-allocated in response to the current allocation information of the current time period being consistent with the allocation information. Thus, efficiency of re-allocation can be improved, and unnecessary re-allocation can be avoided.

In some optional embodiments, the resource of the cloud server further includes a shared resource, and the method further includes that: the shared resource is called and provided for the user in response to the exclusive resource not satisfying a use demand; and the shared resource is released once use of the shared resource has been completed.

The resource of the cloud server further includes the shared resource, and is used in cooperation with the dynamically adjusted exclusive resource, so as to satisfy the sudden resource demand of the user, guarantee that the user has sufficient resource occupation under an emergency condition, and guarantee resource use by the user.

A scheduling apparatus for allocating resources of a cloud server is provided in some embodiments of the present disclosure. The scheduling apparatus includes: a console, and a resource adjustment unit, where the console is used for acquiring, after the cloud server initially allocates an exclusive resource to a user, a resource demand of the user in a target time period; and modifying allocation information of the exclusive resource for the user according to the resource demand, where the exclusive resource is a resource of the cloud server pre-allocated to the user and exclusively used by the user; and the resource adjustment unit is connected with the console and the cloud server, and is used for allocating, according to the allocation information, the exclusive resource to the user in the target time period.

The embodiments of the present disclosure has the beneficial effects: the allocation information is reconfigured before the target time period according to the resource demand of the user in the target time period, and the resources are allocated according to the allocation information in the target time period. Thus, the exclusive resource is dynamically allocated, so as to guarantee that the additional exclusive resource used and placed is dynamically adjusted according to a demand of the exclusive resource, thereby avoiding the situation that a static exclusive resource hardly satisfies a dynamic fluctuant resource demand, and solving the problem of resource waste or resource shortage for the user of the cloud server.

In some optional embodiments, the scheduling apparatus further includes a load data collection unit, where the load data collection unit is connected with the cloud server, and is used for collecting historical load data of the cloud server to extract the historical data for performing resource allocation by the user. The historical load data includes the historical data on resource provision by the cloud server for the user, and the historical data is information for performing resource allocation by the user in a historical time period. The load data collection unit is further connected with the resource adjustment unit, and is used for predicting the resource demand according to the historical data for performing resource allocation by the user, and sending the resource demand to the resource adjustment unit to allocate the resources of the cloud server.

The historical load data recorded by the cloud server is reasonably used to extract the historical data according to the historical load data recorded by the cloud server, so as to predict the resource demand of the user. The user does not need to provide the historical data, thereby improving efficiency of demand prediction. The resource demand of the user is predicted according to the historical data of the user without the user to actually participate in dynamic adjustment of the resource allocation, thereby improving use experience, and preventing increase in workload of the user. The resource demand is selected according to an actual situation during use, thereby improving flexibility of the solution.

An electronic device is provided in some embodiments of the present disclosure. The electronic device includes: a processor, and a memory storing a program, where the program includes instructions, and the instructions causes the processor to execute the method for allocating resources of the cloud server mentioned above when executed by the processor.

A non-transitory machine-readable medium storing computer instructions is provided in some embodiments of the present disclosure. The computer instructions are used for causing a computer to execute the method for allocating resources of the cloud server mentioned above.

The details of at least one embodiment of the present disclosure are provided in the following accompanying drawings and description to make other features, objectives, and advantages of the present disclosure more concise and understandable.

### BRIEF DESCRIPTION OF DRAWINGS

In order to more clearly illustrate the technical solutions in the embodiments of the present disclosure or in the related art, the accompanying drawings required for the description of the embodiments or the related art will be briefly introduced below. Obviously, the accompanying drawings in the following description are some embodiments of the present disclosure, and a person having ordinary skill in the art would further be able to derive other accompanying drawings according to these drawings without making creative efforts.

FIG. 1 is a flowchart of a method for allocating resources of a cloud server according to some embodiments of the present disclosure.

FIG. 2 is a flowchart of another method for allocating resources of a cloud server according to some embodiments of the present disclosure.

FIG. 3 is a flowchart of another method for allocating resources of a cloud server according to some embodiments of the present disclosure.

FIG. 4 is a flowchart of another method for allocating resources of a cloud server according to some embodiments of the present disclosure.

FIG. 5 is a schematic diagram of allocation of a utilization rate of a central processing unit (CPU) in a solution of combining a dynamic exclusive resource and a shared resource according to some embodiments of the present disclosure.

FIG. 6 is a schematic diagram of a scheduling apparatus for allocating resources of a cloud server according to some embodiments of the present disclosure.

FIG. 7 is a structural block diagram of a scheduling apparatus using a solution of combining a dynamic exclusive resource and a shared resource according to some embodiments of the present disclosure.

FIG. 8 is a schematic structural diagram of an electronic device according to some embodiments of the present disclosure.

### DETAILED DESCRIPTION OF THE INVENTION

The embodiments of the present disclosure will be described in more detail below with reference to the accompanying drawings. Although some embodiments of the present disclosure are shown in the accompanying drawings, it should be understood that the present disclosure can be implemented in various forms, and should not be construed as being limited to the embodiments described herein. On the contrary, these embodiments are provided for a more thorough and complete understanding of the present disclosure. It should be understood that the accompanying drawings and the embodiments of the present disclosure are for illustrative purposes, and are not intended to limit the scope of protection of the present disclosure.

Elastic computing can rapidly expand or reduce resources such as processing, memory and storage to satisfy a constantly changing resource demand of a user, without worry about capacity planning and engineering design of at a usage peak. The elastic computing may match an allocated resource amount with an actual required resource amount without an interrupting operation. By means of flexibility of a cloud server, payment for unused capacity or idle resources is avoided, and it is unnecessary to worry about investing money to purchase or maintain additional resources and devices.

The cloud server is a computing service provided by cloud computing, and is presented as a simulated server on which a customer may install and run an operating system and an application.

The cloud server for elastic computing in the related art has various forms of resource delivery, including a static exclusive resource, a static exclusive resource and an uncontrolled shared resource (shared resource free contention), a static exclusive resource and a controlled shared resource (use of the shared resource is limited by a condition), a shared resource (complete free contention), etc. Specific details are as follows.

The first form is the static exclusive resource. In such a form of resource delivery, a performance index of the cloud server is a statically specified maximum value, and it is guaranteed that the maximum value is reachable. For example, a cloud server has a network bandwidth specification of 1 Gbps. This means that network communication of the cloud server may reach the value at a maximum, and is really reachable when the value is needed. The form has the advantage that performance is guaranteed. The form has the disadvantages that on one hand, waste is caused since usually, most cloud servers do not use upper performance limits of specifications of the cloud servers most of time; and on the other hand, performance is damaged, and may not be satisfied when performance greater than a benchmark is needed.

The second form is the static exclusive resource and shared resource. Such a form of resource delivery remedies some defects of the first form of resource delivery to some extent, and allows the cloud server to obtain a performance capacity greater than that of the static exclusive resource when needed. That is, performance of the form has a capability of dynamic burst. Such a form of dynamic burst is further divided into two manners. One manner is controlled. For example, the performance is allowed to burst for 10 minutes in one hour. An integration manner is set as an implementation means of the manner. Such a manner has the disadvantage that the performance is still damaged. The other manner is uncontrolled. Different cloud servers located on the same physical server may freely contend in a particular manner above the benchmark. Such a manner has the disadvantage that burst performance is not guaranteed. Due to existence of the static exclusive resource, resource reservation is still wasted.

The third form is the shared resource. Such a form of resource delivery does not specify a benchmark exclusive resource, or has a weak exclusive resource guaranteeing the benchmark. Cloud servers contend with each other for the limited shared resource. The form has the advantage that maximum performance is obtained when others do not need resources, and has the disadvantage that a contention easily occurs, resulting in resource scramble.

In the related art, no matter which form of resource delivery is used, the size of the static exclusive resource of the cloud server is required to be fixed, and is unchangeable during use of the cloud server. In order to guarantee data stability, the user of the cloud server generally determines the size of the exclusive resource according to a resource demand peak.

The exclusive resource has a higher resource unit price than the shared resource, resulting in resource cost waste for the user during a data valley period. Resource contention is caused by the shared resource during a data peak period, resulting in shortage of usable resource.

In order to solve the problem that resource waste of the cloud server or shortage of resources usable to the user is caused since a method for allocating resources of a cloud server in the related art hardly adapts to a dynamic fluctuant resource demand of a user, a method for allocating resources of a cloud server is provided in the embodiments of the present disclosure. A size of an exclusive resource is dynamically adjusted according to a load characteristic on the cloud server and resource planning of a user, so as to guarantee resource certainty and simultaneously save resource reservation cost. Such a method can effectively help the user reduce cloud cost, and can further improve a resource utilization rate of the cloud server.

The method for allocating resources of the cloud server according to the present disclosure is applicable to an electronic device for scheduling resources of the cloud server. The electronic device may include a notebook computer, a desktop computer, a smart phone, a smart wearable device (such as virtual reality glasses and a smart watch), a tablet computer, etc. Clearly, the method for allocating resources of the cloud server according to the present disclosure is applicable to an application program running in the electronic device. For example, the method for allocating resources of the cloud server is applicable to a browser having a function of instant messaging, or is applicable to instant messaging software.

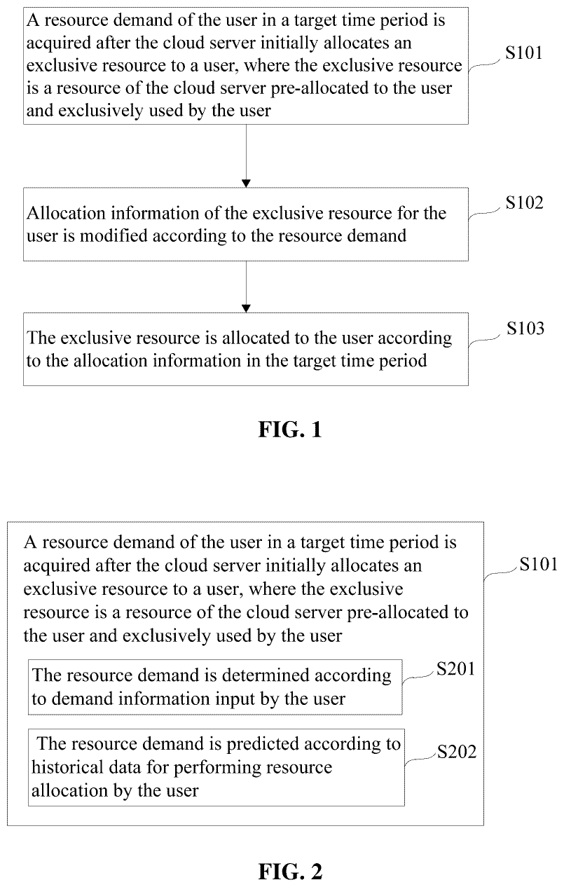

FIG. 1 is a flowchart of a method for allocating resources of a cloud server according to some embodiments of the present disclosure. As shown in FIG. 1, the method for allocating resources of the cloud server according to some embodiments of the present disclosure includes the following steps.

In step S101, a resource demand of the user in a target time period is acquired after the cloud server initially allocates an exclusive resource to a user, where the exclusive resource is a resource of the cloud server pre-allocated to the user and exclusively used by the user.

In step S102, allocation information of the exclusive resource for the user is modified according to the resource demand.

In step S103, the exclusive resource is allocated to the user according to the allocation information in the target time period.

The method for allocating resources of the cloud server according to the embodiments of the present disclosure is applicable to a scheduling apparatus, and is executed by the scheduling apparatus. The allocation information is reconfigured before the target time period according to the resource demand of the user in the target time period, and the resources are allocated according to the allocation information in the target time period. Thus, the exclusive resource can be dynamically allocated, so as to guarantee that the additional exclusive resource used and placed is dynamically adjusted according to a demand of the exclusive resource, thereby avoiding the situation that a static exclusive resource hardly satisfies a dynamic fluctuant resource demand, and solving the problem of resource waste or resource shortage for the user of the cloud server.

During initialization, the cloud server initially allocates the resources once usually according to a default value or a value set before initialization. During initialization allocation, different resources are allocated according to different allocation solutions. For example, the exclusive resource is allocated in response to the allocation solution being the exclusive resource. The exclusive resource and the shared resource are allocated in response to the allocation solution being the exclusive resource and the shared resource. The shared resource is allocated in response to the allocation solution being the shared resource.

Usually, the exclusive resource is static and is unchangeable after initialization allocation. The exclusive resource has the powerful guarantee on the resource demand of the user, and is unchangeable, such that the resource demand of the user hardly generates large fluctuation. When a demand amount of the user is large, the resource is tight. When the demand amount of the user is small, the exclusive resource is wasted.

To this end, the resource demand of the user including the demand of the exclusive resource is acquired in different time periods in some embodiments of the present disclosure, so as to re-allocate the resources of the cloud server according to the demand of the exclusive resource. The exclusive resource is mainly re-allocated, such that the exclusive resource is dynamically adjusted to satisfy the fluctuant resource demand of the user.

The resources of the cloud server include, but not limited to, a central processing unit (CPU), a memory, a graphics processing unit (GPU), a magnetic disk, etc., and further includes performance indexes of computation, network and storage dimensions such as a network bits per second (bps) (port rate), a packet per second (pps) (transmission rate in a unit of a network packet), a cyber-physical system (cps), a session, a storage bps (port rate), and an input/output operations per second (iops) (which refers to the number of input/output (I/O) requests processable by a system per unit time).

Since the cloud server further includes the shared resource, dynamic allocation of the resources in the example is applicable to allocation of the shared resource. That is, the resource demand includes a demand for the shared resource, and the allocation information includes allocation information of the shared resource. Specifically, a shared resource demand of the user of the cloud server in the target time period is acquired, the allocation information of the shared resource of the user is determined according to the shared resource demand, and the resources of the cloud server of the user are allocated according to the allocation information of the shared resource in the target time period.

Considering that the shared resource has performance of dynamic adjustment, when the resources are dynamically allocated according to a time period, the limited shared resource is allocated in consideration of resource demands of multiple users. Thus, each time period has a reasonable initial amount of the shared resource to avoid resource scramble as much as possible. Further, the resources of the cloud server is allocated more reasonably, such that the resource demands of the multiple users of the cloud server are allocated as reasonably as possible.

The allocation information of the user is determined according to the resource demand. Theoretically, equivalent or properly surplus resource allocation is provided according to the resource required by the user. However, since the cloud server usually corresponds to the multiple users, the exclusive resource and the shared resources are limited resources, and are usually paid resources provided for the users.

Thus, when the allocation information of the user is determined according to the resource demand, the pre-allocation information is generated and sent to the user for verification and confirmation. The user properly adjusts the pre-allocation information by means of the opportunity. After the user verifies and confirms the pre-allocation information, the resources is subsequently re-allocated according to the pre-allocation information verified and confirmed as the allocation information.

After the allocation information is obtained, the resources of the cloud server of the user are allocated according to the allocation information in the target time period. Specifically, the resources of the cloud server of the user is allocated by means of a functional device that allocates the resources when the cloud server is initialized. Alternatively, the resources of the cloud server of the user are allocated by separately arranging a device having a function of resource allocation. A principle of the device is the same as that of resource allocation in an initialization process of the cloud server.

When the resources are allocated in the target time period, the resources are allocated according to content included in the allocation information. When the allocation information includes allocation of the exclusive resource, the exclusive resources are re-allocated. When the allocation information includes allocation of the exclusive resource and allocation of the shared resource, the exclusive resource and the shared resource are allocated.

FIG. 2 is a flowchart of another method for allocating resources of a cloud server according to some embodiments of the present disclosure. As shown in FIG. 2, another method for allocating resources of the cloud server is further provided in the embodiments of the present disclosure, and is applied to the scheduling apparatus. Optionally, the method for allocating resources of the cloud server according to the embodiments of the present disclosure is applicable to S101 provided in some embodiments. In step S101, an operation of acquiring the resource demand of the user in the target time period includes the following steps.

In step S201, the resource demand is determined according to demand information input by the user.

Or, in step S202, the resource demand is predicted according to historical data for performing resource allocation by the user, where the historical data is information for performing resource allocation by the user in a historical time period.

According to the method for allocating resources of a cloud server according to the embodiments of the present disclosure, the resource demand of the user is determined according to the demand information input by the user, and better conforms to an actual resource demand of the user. The resource demand of the user is further predicted according to the historical data of the user, and it is unnecessary for the user to actually participate in dynamic adjustment of the resource allocation, thereby improving use experience, and preventing increase in workload of the user. The resource demand is selected according to an actual situation during use, thereby improving flexibility of the solution.

In some other embodiments, a final resource demand is determined by combining a manner of inputting demand information input by the user and a manner of predicting the resource demand according to historical data.

Specifically, after the resource demand is predicted according to the historical data for performing resource allocation by the user, the predicted resource demand is sent to the user. The user performs modification with reference to the predicted resource demand, and inputs the demand information more conforming to the resource demand, so as to determine the resource demand. Alternatively, the user directly confirms the predicted resource demand as a basis for resource allocation in the target time period.

Thus, a more accurate resource demand is obtained, and accuracy of resource allocation in the target time period is improved.

The step that the resource demand is determined according to demand information input by the user is executed by means of an interactive interface or an interactive device with the user. Under the condition that the resource demand needs to be acquired, an input interface of the demand information is displayed by means of the interactive interface or the interactive device, and the user inputs the demand information based on the input interface. The demand information includes a usage of resources and a specific value of each resource parameter.

In the step that the resource demand is predicted according to historical data for performing resource allocation by the user, the resource demand is predicted by means of an artificial intelligence model, or by means of linear regression, and other prediction manners in which a subsequent data development state is predicted according to a historical data development trend.

The manner in which prediction is performed by means of the artificial intelligence model is taken as an example. The artificial intelligence model is trained by means of training data. The training data includes historical data and resource data of a time period to be predicted. After the artificial intelligence model is trained and converged, the historical data is input into the artificial intelligence model to output the predicted resource demand of the target time period.

In some optional embodiments, an operation of predicting the resource demand according to historical data for performing resource allocation by the user includes the following steps. Historical load data of the cloud server is collected to extract the historical data, where the historical load data includes the historical data on resource provision by the cloud server for the user. The resource demand is predicted according to the historical data.

The historical load data recorded by the cloud server is reasonably used to extract the historical data according to the historical load data recorded by the cloud server, so as to predict the resource demand of the user. The user does not need to provide the historical data, thereby improving efficiency of demand prediction.

The cloud server has a function of recording a resource use condition and an actual allocation condition of the user. Since resource use of the user is part of a load relative to the cloud server, resource use condition and actual allocation condition of the user on the cloud server are collectively referred to as the historical load data.

When the historical load data of the cloud server is collected, the historical load data of the historical time period corresponding to the historical data is acquired from the cloud server. Clearly, the historical load data including the historical time period is acquired. It should be noted that considering that a large amount of load data in the historical time period exist, and the resources are dynamically adjusted according to a period to some extent, the historical data of the predicted resource demand is overlapped in multiple dynamic adjustment of the resources processes.

In order to cope with the case, after the historical load data is acquired, the historical load data is properly cached for a time period. Detection is performed before the historical load data is collected each time, so as to determine whether the historical data is overlapped. When the historical data required by current demand prediction overlaps the cached historical load data, newly added historical load data that needs to be acquired is determined based on existing historical load data in a cache, and then corresponding newly added historical load data is acquired from the cloud service. Thus, a speed of acquiring the historical load data can be effectively increased, a data acquisition amount is reduced, and resource occupation is reduced.

The function of the cloud server and the existing historical load data are reasonably used, and the historical data is directly extracted, thereby solving the problem that a load of data acquisition is increased by separately collecting data on the user to acquire the historical data, resulting in low efficiency of data acquisition.

In some optional embodiments, the historical data on resource provision by the cloud server for the user includes historical allocation data of each demand level in the historical time period, and an operation of collecting historical load data of the cloud server to extract the historical data for performing resource allocation by the user includes the following steps. Resource data occupied by data having a demand level reaching a preset level in the historical load data is set as the historical allocation data of the exclusive resource.

The historical allocation data of the exclusive resource is extracted from the historical load data according to the resource data occupied by the data having the demand level reaching the preset level. The corresponding exclusive resource in the historical load data determined according to division of the preset level is set as the historical allocation data, and the exclusive resource recorded according to the historical load data is not directly set as the historical allocation data, such that the demand of the user can be better satisfied, thereby solving the problem of inaccurate resource demand prediction caused by a change in a use demand.

Since the exclusive resource is a resource providing a powerful guarantee for the user, and the powerful guarantee is relative, in the example, the data having the demand level reaching the preset level is regarded as data requiring the powerful guarantee from the user. Relatively, a weak guarantee is understood as data having the demand level not reaching the preset level.

When the historical data is extracted from the historical load data, the resource demand of the user usually is not intentionally distinguished as the powerful guarantee or the weak guarantee. Moreover, different time periods have different urgencies for data resources having different demand levels. That is, data ranges of the powerful guarantee or the weak guarantee in different time periods are different.

Thus, data having the powerful guarantee needs to be determined according to the demand level, so as to further determine an actual demand of the user for the exclusive resource in the historical data. The resource demand in the target time period is better satisfied instead of data division used by allocation of the exclusive resource at the time, thereby improving accuracy of prediction of the resource demand.

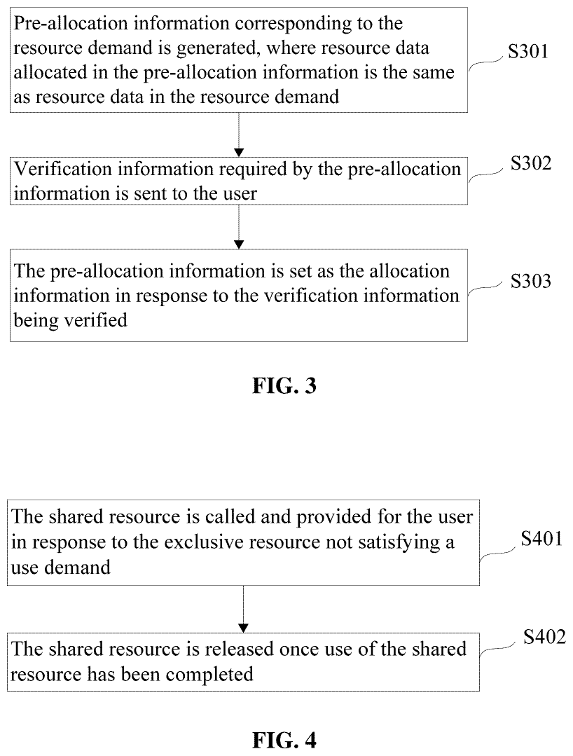

FIG. 3 is a flowchart of another method for allocating resources of a cloud server according to some embodiments of the present disclosure. As shown in FIG. 3, another method for allocating resources of the cloud server is further provided in the embodiments of the present disclosure, and is applied to the scheduling apparatus. Optionally, the method for allocating resources of the cloud server according to the embodiments of the present disclosure is applicable to S102 provided in some embodiments. In step S102, an operation of modifying allocation information of the exclusive resource for the user according to the resource demand includes the following steps.

In step S301, pre-allocation information corresponding to the resource demand is generated, where resource data allocated in the pre-allocation information is the same as resource data in the resource demand.

In step S302, verification information required by the pre-allocation information is sent to the user.

In step S303, the pre-allocation information is set as the allocation information in response to the verification information being verified.

According to the method for allocating resources of a cloud server according to the embodiments of the present disclosure, the resources of the cloud server are re-allocated, and the allocated resources are changed, thereby affecting use by the user. Thus, the pre-allocation information needs to be determined according to the resource demand, and is sent to the user for verification and confirmation. The pre-allocation information is set as the allocation information to allocate the resources in response to the verification information being verified.

The pre-allocation information provides equivalent or properly surplus resource allocation according to the resource required by the user. That is, the resource data allocated in the pre-allocation information is the same as the resource data in the resource demand, or is properly greater than the resource data in the resource demand. The properly surplus resource allocation is to completely cover the resource demand, thereby avoiding the situation that the resource demand may not be completely satisfied due to a performance reason.

However, since the pre-allocation information needs to be sent to the user for verification, the user may properly modify the pre-allocation information during verification. The pre-allocation information that is the same as the resource data in the resource demand is used in the example, so as to avoid unnecessary resource occupancy. After it is determined that the verification information is verified, properly surplus resource allocation is performed to obtain the allocation information.

Multiple types of verification is performed in the manner of verification and confirmation, and include permission verification, identity verification, security verification, payment verification, etc. to guarantee activeness of the user to resource adjustment, and avoid loss to the user caused by a malicious attack.

The step that verification information required by the pre-allocation information is sent to the user is executed by means of the interactive interface or the interactive device. A verification interface is displayed on the interactive interface or the interactive device, and the user operates on the verification interface for verification.

It should be noted that for a verification operation, verification is performed by means of data interaction of different pages or third-party devices according to a verification demand.

In some optional embodiments, the verification required by the pre-allocation information includes payment verification, verification information of the payment verification includes a payment link, and an operation of sending verification information required by the pre-allocation information to the user includes the following steps. The payment link of the payment verification is sent to the user. It is determined that the payment verification succeeds in response to payment having been successfully processed via the payment link.

The resources of the cloud server are paid resources provided, and the payment verification is performed by means of the payment link. The pre-allocation information is set as allocation information to allocate the resources in the target time period in response to the verification information being verified.

The payment link is jumped to a third-party paid server or a third-party paid page for payment. After the verification information is verified, the third-party paid server feeds back information on successful payment, and determines that the verification information is verified.

In some optional embodiments, an operation of allocating, according to the allocation information, the exclusive resource to the user in the target time period includes the following step. Current allocation information for performing resource allocation by the user in a current time period is acquired, where the target time period is a next time period after the current time period. The current allocation information is adjusted to the allocation information in the target time period in response to the current allocation information being inconsistent with the allocation information; and the resource allocation is executed according to the current allocation information in the target time period in response to the current allocation information being consistent with the allocation information.

When the resources of the cloud server are allocated according to the allocation information, whether the current allocation information is consistent with the allocation information is compared. The resources are re-allocated in response to the current allocation information of the current time period being inconsistent with the allocation information. The resources are not re-allocated in response to the current allocation information of the current time period being consistent with the allocation information. Thus, efficiency of re-allocation can be improved, and unnecessary re-allocation can be avoided.

FIG. 4 is a flowchart of another method for allocating resources of a cloud server according to some embodiments of the present disclosure. As shown in FIG. 4, another method for allocating resources of the cloud server is further provided in the embodiments of the present disclosure, and is applied to the scheduling apparatus. Optionally, the resources of the cloud server further include a shared resource, and apart from steps S101-S103, the method for allocating resources of the cloud server further includes the following steps.

In step S401, the shared resource is called and provided for the user in response to the exclusive resource not satisfying a use demand.

In step S402, the shared resource is released once use of the shared resource has been completed.

According to the method for allocating resources of a cloud server according to the embodiments of the present disclosure, the resources of the cloud server further include the shared resource, and are used in cooperation with the dynamically adjusted exclusive resource, so as to satisfy the sudden resource demand of the user, guarantee that the user has sufficient resource occupation under an emergency condition, and guarantee resource use by the user.

A manner of “dynamic exclusive resource and shared resource” is provided based on an original manner of resource delivery of the cloud server in some embodiments.

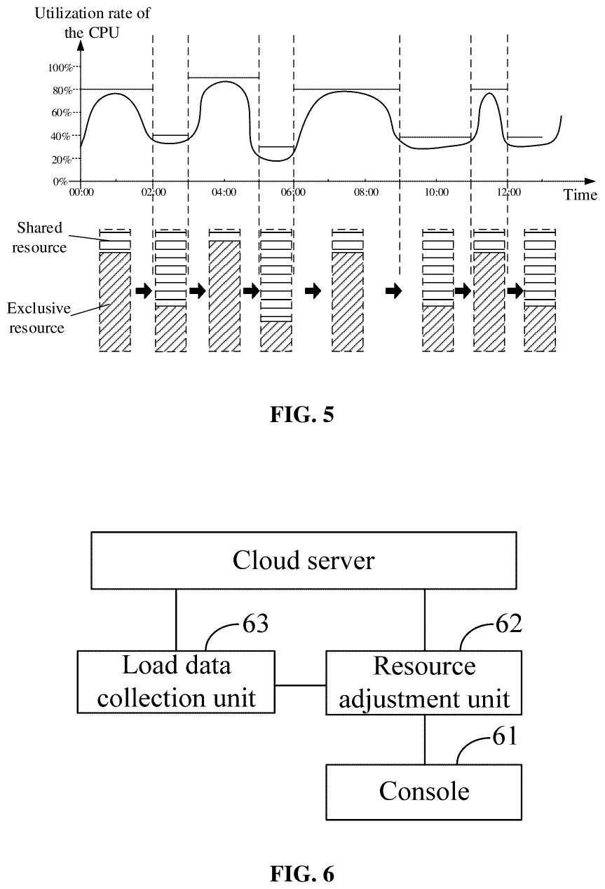

FIG. 5 is a schematic diagram of allocation of a utilization rate of a central processing unit (CPU) in a solution of combining a dynamic exclusive resource and a shared resource according to some embodiments of the present disclosure. As shown in FIG. 5, an initial allocation proportion of an exclusive resource to a shared resource exists when the cloud server is initialized, that is, when time is 0. Then 80% of the utilization rate of the CPU is allocated as the exclusive resource, and the remaining 20% is set as the shared resource.

During running of the cloud server, as time changes, for a resource demand requiring a powerful guarantee, a size of an exclusive resource is adjusted according to a demand. As shown in the figure, at 02:00 after 2 hours, since a demand of the user is reduced, 40% of the utilization rate of the CPU is allocated as the exclusive resource, and the remaining 60% is set as the shared resource. At 03:00 after 1 hour, since the demand of the user is increased, 90% of the utilization rate of the CPU is allocated as the exclusive resource, and the remaining 10% is set as the shared resource. It should be noted that a time period of dynamic adjustment is unfixed or fixed.

The cloud server performs charging corresponding to a result after adjustment, and then performs adjustment after charging.

The cloud server provides two adjustment manners. The user performs planning according to the resource demand of the user, and adjust the exclusive resource by means of a console or an application programming interface (API) self-service. The user hosts the capability of dynamic adjustment to the cloud server, a time sequence is predicted based on a load condition of the cloud server, and corresponding adjustment is performed.

FIG. 6 is a schematic diagram of a scheduling apparatus for allocating resources of a cloud server according to some embodiments of the present disclosure. As shown in FIG. 6, based on the method for allocating resources of the cloud server according to the embodiments of the present disclosure, the scheduling apparatus for allocating resources of the cloud server is further provided in some embodiments of the present disclosure. The scheduling apparatus is applied to schedule the resources of the cloud server, and includes: a console 61, and a resource adjustment unit 62.

The console 61 is used for acquiring, after the cloud server initially allocates an exclusive resource to a user, a resource demand of the user in a target time period; and modifying allocation information of the exclusive resource for the user according to the resource demand, where the exclusive resource is a cloud server resource pre-allocated to the user and exclusively used by the user. The resource adjustment unit 62 is connected with the console 61 and the cloud server, and is used for allocating, according to the allocation information, the exclusive resource to the user in the target time period.

According to the scheduling apparatus for allocating resources of the cloud server according to the embodiments of the present disclosure, the allocation information is reconfigured before the target time period according to the resource demand of the user in the target time period, and the resources are allocated according to the allocation information in the target time period. Thus, the exclusive resource can be dynamically allocated, so as to guarantee that the additional exclusive resource used and placed is dynamically adjusted according to a demand of the exclusive resource, thereby avoiding the situation that a static exclusive resource hardly satisfies a dynamic fluctuant resource demand, and solving the problem of resource waste or resource shortage for the user of the cloud server.

In some optional embodiments, the scheduling apparatus further includes a load data collection unit 63, where the load data collection unit is connected with the cloud server, and is used for collecting historical load data of the cloud server to extract the historical data for performing resource allocation by the user. The historical load data includes the historical data on resource provision by the cloud server for the user, and the historical data is information for performing resource allocation by the user in a historical time period. The load data collection unit is further connected with the resource adjustment unit, and is used for predicting the resource demand according to the historical data for performing resource allocation by the user, and sending the resource demand to the resource adjustment unit to allocate the resources of the cloud server.

The historical load data recorded by the cloud server is reasonably used to extract the historical data according to the historical load data recorded by the cloud server, so as to predict the resource demand of the user. The user does not need to provide the historical data, thereby improving efficiency of demand prediction. The resource demand of the user is predicted according to the historical data of the user without the user to actually participate in dynamic adjustment of the resource allocation, thereby improving use experience, and preventing increase in workload of the user. The resource demand is selected according to an actual situation during use, thereby improving flexibility of the solution.

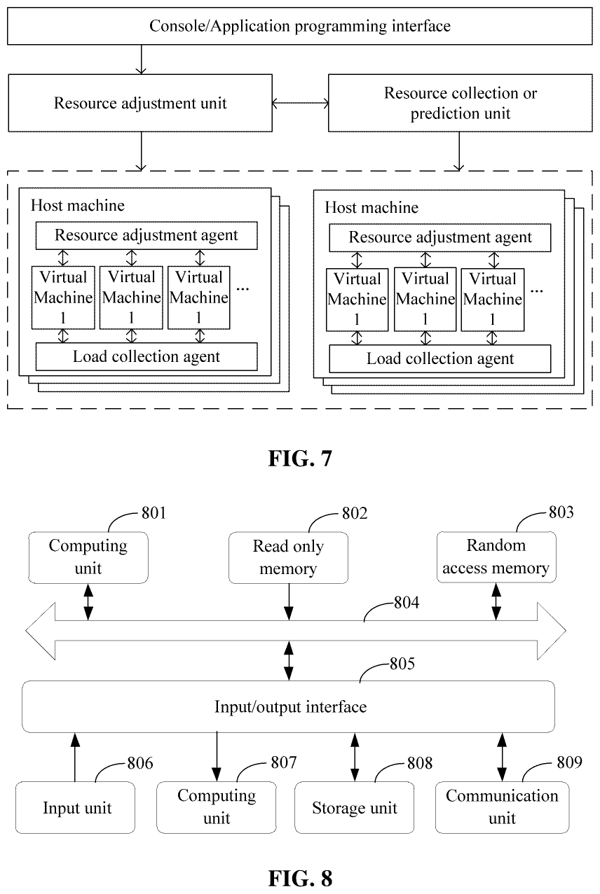

FIG. 7 is a structural block diagram of a scheduling apparatus using a solution of combining a dynamic exclusive resource and a shared resource according to some embodiments of the present disclosure. As shown in FIG. 7, an apparatus for dynamically adjusting an exclusive resource of a cloud server is further provided. The apparatus includes a console, a resource adjustment unit, and a resource collection or prediction unit. The resource collection or prediction unit is equivalent to the load data collection unit.

The resource adjustment unit is responsible for configuration management of a size of an exclusive resource of the cloud server, and receiving a console or API request. The load collection or prediction unit collects historical load data of the cloud server by means of a load collection agent running on a host machine; and further predicts a load time sequence based on the collected data, and provides a resource adjustment suggestion according to a prediction result.

An electronic device is further provided in some embodiments of the present disclosure. The electronic device includes: at least one processor, and a memory communicatively connected with the at least one processor. The memory stores a computer program executable by the at least one processor, and the computer program is used for causing the electronic device to execute the method of the embodiments of the present disclosure when executed by the at least one processor.

A non-transitory machine-readable medium storing a computer program is further provided in some embodiments of the present disclosure. The computer program is used for causing a computer to execute the method of the embodiments of the present disclosure when executed by a processor of the computer.

A computer program product is further provided in some embodiments of the present disclosure. The computer program product includes a computer program. The computer program is used for causing a computer to execute the method of the embodiments of the present disclosure when executed by a processor of a computer.

As shown in FIG. 8, a structural block diagram of an electronic device set as a server or a client of some embodiments of the present disclosure is described below. The structural block diagram is an example of a hardware device applicable to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device further represents various forms of mobile apparatuses, such as a personal digital assistant, a cellular telephone, a smart phone, a wearable device, and other similar computing apparatuses. The components illustrated herein, and connection relations and functions of the components are examples, and are not intended to limit implementations of the present disclosure described and/or required herein.

As shown in FIG. 8, the electronic device includes a computing unit 801 that executes various suitable actions and processes according to a computer program stored in a read only memory (ROM) 802 or a computer program loaded from a storage unit 808 into a random access memory (RAM) 803. Various programs and data necessary for the operation of the electronic device are further stored in the RAM 803. The computing unit 801, the ROM 802 and the RAM 803 are connected with each other by means of a bus 804. An Input/output (I/O) interface 805 is also connected with the bus 804.

Multiple components in the electronic device are connected with the I/O interface 805, and include: an input unit 806, an output unit 807, the storage unit 808, and a communication unit 809. The input unit 806 is any type of device that inputs information to the electronic device. The input unit 806 receives input digit or character information, and generates a key signal input related to a user setting and/or function control of the electronic device. The output unit 807 is any type of device that presents information, and includes, but not limited to, a display, a speaker, a video/audio output terminal, a vibrator, and/or a printer. The storage unit 808 includes, but not limited to, a magnetic disk and an optical disc. The communication unit 809 allows the electronic device to exchange information/data with other devices by means of a computer network such as Internet and/or various telecommunication networks, and includes, but not limited to, a modem, a network card, an infrared communications device, a wireless communication transceiver and/or a chip set, for example, a Bluetooth device, a wireless fidelity (WiFi) device, a world interoperability for microwave access (WiMax) device, a cellular communications device, and/or the like.

The computing unit 801 is a variety of general purpose and/or special purpose processing components having processing and computing capabilities. Some examples of the computing unit 801 include, but not limited to, a CPU, a GPU, various dedicated artificial intelligence (AI) computing chips, various computing units running machine learning model algorithms, a digital signal processor (DSP), and any suitable processor, controller, microcontroller, etc. The computing unit 801 executes the methods and processes described above. For example, in some embodiments, the method embodiments of the present disclosure are implemented as a computer program that is tangibly included in a machine-readable medium such as the storage unit 808. In some embodiments, a computer program is loaded and/or installed on an electronic device in part or in whole by means of a ROM 802 and/or a communication unit 809. In some embodiments, a computing unit 801 is configured to execute the method in any other suitable way (for example, by means of firmware).

Computer programs for implementing the method embodiments of the present disclosure are written in any combination of at least one programming language. These computer programs are provided to a processor or a controller of a general purpose computer, a special purpose computer, or other programmable data processing apparatuses, such that the computer programs cause functions/operations specified in the flowchart and/or the block diagram to be implemented when executed by the processor or the controller. The computer programs are executed entirely on a machine and partly on the machine, and are executed partly on the machine and partly on a remote machine or entirely on the remote machine or a server as a stand-alone software package.

In the context of the embodiments of the present disclosure, the machine-readable medium is a tangible medium that may include or store a program used by an instruction execution system, apparatus, or device or used in combination with an instruction execution system, apparatus, or device. The machine-readable medium is a computer-readable signal medium or a computer-readable storage medium. The machine-readable medium includes, but not limited to, an electronic, magnetic, optical, electromagnetic, infrared, or semiconductor system, apparatus, or device, or any suitable combination of the above. More specific examples of the machine-readable storage medium include an electrically connected based on at least one wire, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combination of the above.

It should be noted that the terms “include” and variations thereof used in the embodiments of the present disclosure are open-ended, i.e. “include, but not limited to”. The term “based on” is “at least partially based on”. The term “an embodiment” represents “at least one embodiment”. The term “another embodiment” represents “at least one another embodiment”. The term “some embodiments” represents “at least some embodiments”. Modifications of “a”, “an” and “multiple” mentioned in the embodiments of the present disclosure are illustrative rather than limiting, and a person having ordinary skill in the art should understand that “at least one” should be understood unless explicitly stated otherwise in the context.

User information (including, but not limited to, user equipment information, user personal information, etc.) and data (including, but not limited to, data for analysis, stored data, displayed data, etc.) involved in the embodiments of the present disclosure are information and data that are authorized by a user or that are sufficiently authorized by all parties, related data needs to be collected, used, and processed in accordance with related laws and regulations and standards of related countries and regions, and corresponding operation entries are provided for the user to select authorization or rejection.

The steps recorded in the method embodiments according to the embodiments of the present disclosure can be executed in different orders and/or in parallel. In addition, the method embodiments can include additional steps and/or steps shown for execution omission. The scope of protection of the present disclosure is not limited in this regard.

The word “embodiment” in the present disclosure refers to specific features, structures, or characteristics described in combination with the embodiments that can be included in at least one embodiments of the present disclosure. The phrase in various positions in the description does not necessarily mean the same example, and does not mean that it is exclusive to other embodiments and is independent or optional. Each embodiment of the present disclosure is described in a progressive manner, and the same and similar parts between the embodiments refer to each other. In particular, the apparatus, device and system embodiments are basically similar to the method example, and are thus described simply, and for relevant content, reference is made to part of the description of the method example.

The embodiments described above are some embodiments of the present disclosure, are specifically described in details, but cannot be interpreted as limiting the scope of protection of the patent as a result. It should be noted that a person having ordinary skill in the art can further make several transformations and improvements on the premise of not deviating from the conception of the present disclosure, and these transformations and improvements should fall within the scope of protection of the present disclosure. Thus, the scope of protection of the present disclosure should be subject to the appended claims.

1. A method for allocating resources of a cloud server, comprising:
acquiring, after the cloud server initially allocates an exclusive resource to a user, a resource demand of the user in a target time period, wherein the exclusive resource is a resource of the cloud server pre-allocated to the user and exclusively used by the user;
modifying allocation information of the exclusive resource for the user according to the resource demand; and
allocating, according to the allocation information, the exclusive resource to the user in the target time period.

2. The method for allocating resources according to claim 1, wherein acquiring the resource demand of the user in the target time period comprises:
predicting the resource demand according to historical data for performing resource allocation by the user, wherein the historical data is information for performing resource allocation by the user in a historical time period.

3. The method for allocating resources according to claim 2, wherein predicting the resource demand according to the historical data for performing resource allocation by the user comprises:
collecting historical load data of the cloud server to extract the historical data for performing resource allocation by the user, wherein the historical load data comprises historical data on resource provision by the cloud server for the user; and
predicting the resource demand according to the historical data for performing resource allocation by the user.

4. The method for allocating resources according to claim 3, wherein the historical data on resource provision by the cloud server for the user comprises historical allocation data of each demand level in the historical time period, and collecting the historical load data of the cloud server to extract the historical data for performing resource allocation by the user comprise:
setting resource data occupied by data having a demand level reaching a preset level in the historical load data as the historical allocation data of the exclusive resource.

5. The method for allocating resources according to claim 1, wherein modifying the allocation information of the exclusive resource for the user according to the resource demand comprises:
generating pre-allocation information corresponding to the resource demand, wherein resource data allocated in the pre-allocation information is the same as resource data in the resource demand;
sending verification information required by the pre-allocation information to the user; and
setting the pre-allocation information as the allocation information in response to the verification information being verified.

6. The method for allocating resources according to claim 5, wherein verification required by the pre-allocation information comprises payment verification, verification information of the payment verification comprises a payment link, and sending the verification information required by the pre-allocation information to the user comprises:
sending the payment link of the payment verification to the user; and
determining that the payment verification succeeds in response to payment having been successfully processed via the payment link.

7. The method for allocating resources according to claim 1, wherein allocating, according to the allocation information, the exclusive resource to the user in the target time period comprises:
acquiring current allocation information for performing resource allocation by the user in a current time period, wherein the target time period is a next time period after the current time period;
adjusting the current allocation information to the allocation information in the target time period in response to the current allocation information being inconsistent with the allocation information; and
executing the resource allocation according to the current allocation information in the target time period in response to the current allocation information being consistent with the allocation information.

8. The method for allocating resources according to claim 1, wherein the resource of the cloud server further comprises a shared resource, and the method further comprises:
calling and providing the shared resource for the user in response to the exclusive resource not satisfying a use demand; and
releasing the shared resource once use of the shared resource has been completed.

9. A scheduling apparatus for allocating resources of a cloud server, comprising: a console, and a resource adjustment unit, wherein
the console is used for acquiring, after the cloud server initially allocates an exclusive resource to a user, a resource demand of the user in a target time period; and modifying allocation information of the exclusive resource for the user according to the resource demand, wherein the exclusive resource is a resource of the cloud server pre-allocated to the user and exclusively used by the user; and
the resource adjustment unit is connected with the console and the cloud server, and is used for allocating, according to the allocation information, the exclusive resource to the user in the target time period.

10. The scheduling apparatus according to claim 9, further comprising: a load data collection unit, wherein
the load data collection unit is connected with the cloud server, and is used for collecting historical load data of the cloud server to extract the historical data for performing resource allocation by the user, wherein the historical load data comprises historical data on resource provision by the cloud server for the user, and the historical data is information for performing resource allocation by the user in a historical time period; and
the load data collection unit is further connected with the resource adjustment unit, and is used for predicting the resource demand according to the historical data for performing resource allocation by the user, and sending the resource demand to the resource adjustment unit to allocate the resources of the cloud server.

11. An electronic device, comprising: a processor, and a memory storing a program, wherein the program comprises instructions, and the instructions causes the processor to execute the following steps when executed by the processor:
acquiring, after the cloud server initially allocates an exclusive resource to a user, a resource demand of the user in a target time period, wherein the exclusive resource is a resource of the cloud server pre-allocated to the user and exclusively used by the user;
modifying allocation information of the exclusive resource for the user according to the resource demand; and
allocating, according to the allocation information, the exclusive resource to the user in the target time period.

12. (canceled)

13. The method for allocating resources according to claim 1, wherein during initialization allocation, different resources are allocated according to different allocation solutions.

14. The method for allocating resources according to claim 1, wherein the method for allocating resources further comprises:
acquiring a shared resource demand of the user in the target time period;
modifying allocation information of a shared resource of the user according to the shared resource demand; and
allocating resources of the cloud server of the user according to the allocation information of the shared resource in the target time period.

15. The method for allocating resources according to claim 2, wherein the method for allocating resources further comprises:
after predicting the resource demand according to the historical data, sending the predicted resource demand to the user, so that the user performs modification with reference to the predicted resource demand to input demand information conforming to the resource demand, so as to determine the resource demand.

16. The method for allocating resources according to claim 2, wherein historical load data comprise resource use condition and actual allocation condition of the user on the cloud server.

17. The method for allocating resources according to claim 1, wherein modifying the allocation information of the exclusive resource for the user according to the resource demand, comprising:
generating pre-allocation information corresponding to the resource demand, wherein resource data allocated in the pre-allocation information is greater than resource data in the resource demand;
sending verification information required for the pre-allocation information to the user; and
in response to the verification information being verified, determining the pre-allocation information as the allocation information.

18. The method for allocating resources according to claim 6, wherein verification required by the pre-allocation information further comprises permission verification, identity verification, and security verification.

19. The method for allocating resources according to claim 2, wherein predicting the resource demand according to the historical data for performing resource allocation by the user comprises:
inputting the historical data for performing resource allocation by the user into an artificial intelligence model, to output a predicted resource demand of the target time period.

20. The method for allocating resources according to claim 19, wherein the method for allocating resources further comprises:
training the artificial intelligence model by means of training data, wherein the training data comprises the historical data and resource data of a time period to be predicted.

21. The method for allocating resources according to claim 1, wherein acquiring the resource demand of the user in the target time period comprises:
determining the resource demand according to demand information input by the user.
